(19) United States
(12) Patent Application Publication
(10) Pub. No.: US 2005/0160086 A1
(43) Pub. Date: Jul. 21, 2005

(54) Information extraction apparatus and method

(75) Inventors: Takuma Haraguchi, Tokyo (JP); Hideo Umeki, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/017,776

(22) Filed: Dec. 22, 2004

(30) Foreign Application Priority Data
Dec. 26, 2003 (JP) P2003-433171

(51) Int. Cl. G06F 7/00

(52) U.S. Cl. 707/3

(57) ABSTRACT

A message input unit inputs a message. A message memory stores the message. An information extraction rule memory stores a plurality of information extraction rules. An information extraction decision unit decides whether at least one of the plurality of information extraction rules is applicable to the message at a decision timing. An information extraction unit extracts information from the message using at least one information extraction rule when the at least one information extraction rule is applicable to the message.

### CROSS-REFERENCE TO RELATED APPLICATIONS

This application is based upon and claims the benefit of priority from prior Japanese Patent Application P2003-433171, filed on Dec. 26, 2003; the entire contents of which are incorporated herein by reference.

### FIELD OF THE INVENTION

The present invention relates to an information extraction apparatus and method for extracting information from messages exchanged and stored through a computer network.

### BACKGROUND OF THE INVENTION

Recently, an electronic communication means to mutually exchange messages among a plurality of users through a communication network is widely spread. The electronic communication means, such as an E-mail, a mailing list, a bulletin board system (BBS), and a chat room, is an indispensable technique in daily business and personal use.

However, a quantity of information transferred by the electronic communication means is enormous, and a user may overlook important information included in messages or the user may not understand a flow of discussion expanded over a plurality of messages. Furthermore, in the case of searching necessary information using a retrieval system, a presentation format as a retrieval key is simple. As a result, retrieval information using the retrieval key includes unnecessary information, and reutilization of the retrieval information is poor. Accordingly, in order to improve reutilization of information, information extraction technique to previously extract information from stored messages and preserve the information in another resource is developed.

For example, in Japanese Patent Disclosure (Kokai) PH9-269940, a mechanism for extracting schedule data from received E-mail and presenting the schedule data is disclosed. In this apparatus, extraction is executed based on a rule to extract a matter as daily information.

Furthermore, in Japanese Patent Disclosure (Kokai) 2003-006122, a mechanism for analyzing stored E-mail, creating a candidate of information extraction rule and presenting the candidate, is disclosed.

Furthermore, in “Extraction of schedules and To-Do items from E-mail messages by identifying messages structures and using language expressions, T. Hasegawa et al., IPSJ. Journal, vol.40, No.10, pp.3694-3705, October 1999”, a mechanism for extracting data-related information and a To-Do list from E-mail messages is disclosed.

As mentioned-above, several techniques to extract information from stored messages and to preserve the information in another resource are provided. However, problems to be solved are included as follows.

First, as for contents of communication or a number of messages related to one topic, new effective information is not always obtained by execution of information extraction. Briefly, an execution timing of information extraction is important. However, an apparatus to execute information extraction at a suitable timing is not provided yet.

Second, if an information extraction condition such as a range of information resource as an extraction object or a kind of information to be extracted, and a parameter of display format of extracted information, are combined, a user's indication of the information extraction condition and the parameter is very troublesome for the user whenever information extraction is executed. Irrespective of a public user or an expert user of operation technique such as information retrieval, it is difficult work for them to imagine which information is extractable from stored messages and by which format the extracted information is presentable.

### SUMMARY OF THE INVENTION

The present invention is directed to an information extraction apparatus and method able to improve a user's operability by controlling execution of information extraction.

According to an aspect of the present invention, there is provided an information extraction apparatus, comprising: a message input unit configured to input a message; a message memory configured to store the message; an information extraction rule memory configured to store a plurality of information extraction rules; an information extraction decision unit configured to decide whether at least one of the plurality of information extraction rules is applicable to the message; and an information extraction unit configured to extract information from the message using at least one information extraction rule when the at least one information extraction rule is applicable to the message.

According to another aspect of the present invention, there is also provided an information extraction method, comprising: inputting a message; storing the message; storing a plurality of information extraction rules; deciding whether at least one of the plurality of information extraction rules is applicable to the message; and extracting information from the message using at least one information extraction rule when the at least one information extraction rule is applicable to the message.

According to still another aspect of the present invention, there is also provided a computer program product, comprising: a computer readable program code embodied in said product for causing a computer to extract information, said computer readable program code comprising: a first program code to input a message; a second program code to store the message; a third program code to store a plurality of information extraction rules; a fourth program code to decide whether at least one of the plurality of information extraction rules is applicable to the message; and a fifth program code to extract information from the message using at least one information extraction rule when the at least one information extraction rule is applicable to the message.

### BRIEF DESCRIPTION OF THE DRAWINGS

FIG. 1 is a block diagram of an information extraction apparatus according to a first embodiment of the present invention.

FIG. 2 is one example of a message input screen.

FIG. 3 is another example of the message input screen.

FIG. 4 is one example of an editing screen of information extraction rule according to the first embodiment of the present invention.

FIG. 5 is one example of a display screen of extraction result according to the first embodiment of the present invention.

FIG. 6 is one example of editing screen of extraction result according to an embodiment of the present invention.

FIG. 7 is one example of a set screen of automatic information extraction according to the first embodiment of the present invention.

FIG. 8 is a flow chart of generic processing of information extraction according to the first embodiment of the present invention.

FIG. 9 is a flow chart of detail processing of decision of information extraction according to the first embodiment of the present invention.

FIG. 10 is one example of a display screen of proposal of information extraction according to the first embodiment of the present invention.

FIG. 11 is a block diagram of a main part of the information extraction apparatus according to a second embodiment of the present invention.

FIG. 12 is a flow chart of editing support processing of information extraction rule according to the second embodiment of the present invention.

FIG. 13 is one example of an editing support screen of information extraction according to the second embodiment of the present invention.

FIG. 14 is one example of a detail editing screen of information extraction rule according to the second embodiment of the present invention.

FIG. 15 is one example of an editing support screen of information extraction rule according to the second embodiment of the present invention.

FIG. 16 is one example of the detail editing screen to supplement the information extraction rule according to the second embodiment of the present invention.

### DETAILED DESCRIPTION OF THE EMBODIMENTS

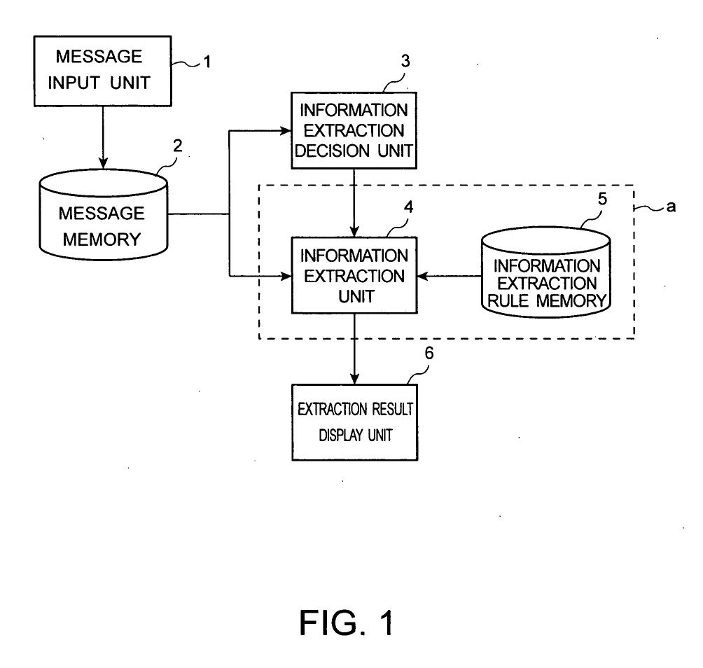

Hereinafter, various embodiments of the present invention will be explained by referring to the drawings. FIG. 1 is a block diagram of the information extraction apparatus according to a first embodiment of the present invention. The information extraction apparatus can be realized as a computer program, and includes a message input unit 1, a message memory 2, an information extraction decision unit 3, an information extraction unit 4, an information extraction rule memory 5, and an extraction result display unit 6.

A message input unit 1 inputs a message, for example, by the user's operating a keyboard, and the message is stored in the message memory 2. The information extraction decision unit 3 decides whether information extraction is executable from a plurality of messages stored in the message memory 2 at a predetermined timing. In the case of deciding that information extraction is executable, the information extraction decision unit 3 outputs an instruction to execute information extraction using a predetermined method to the information extraction unit 4. The predetermined method includes a display method of extraction result by automatic information extraction and a proposal of information extraction. Furthermore, execution of information extraction based on the user's operation without automatic extraction may be indicated to the information extraction decision unit 3.

In response to an execution instruction of information extraction from the information extraction decision unit 3, the information extraction unit 4 obtains messages as an object of information extraction from the message memory 2, and extracts information from the messages based on an information extraction rule. The information extraction rule is stored in the information extraction rule memory 5, and each information extraction rule includes an extraction pattern, an extraction object, and a display format. The information extraction rule memory 5 previously stores at least one prescribed information extraction rule. The user can edit the information extraction rule. The extraction result display unit 6 displays an information extraction result by the display format based on the information extraction rule.

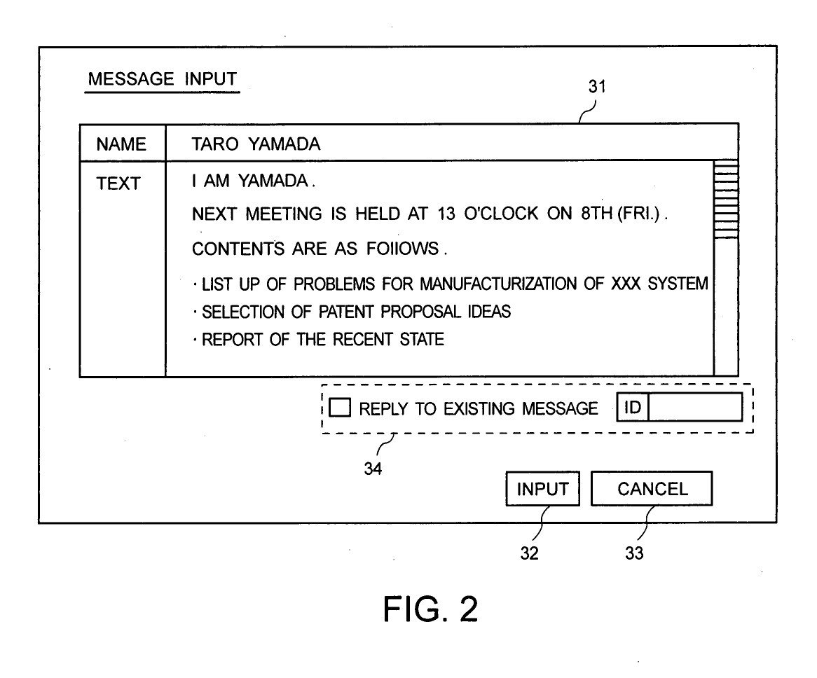

FIG. 2 is one example of a message input screen. This message input screen corresponds to the message input unit 1, and represents a simple example such as BBS. When the user edits a field 31 (including a name and a text) and pushes an input button 32, this message input is determined. By pushing a cancel button 33, this message input is cancelled. By selecting a field 34 and inputting ID, this message is processed as a reply to the existing message of this ID. A message as a reply object is called a parent message, and ID of this message is called a parent message ID.

The input message with the ID, a name of input user, an input time, and the parent message ID is stored in the message memory 2.

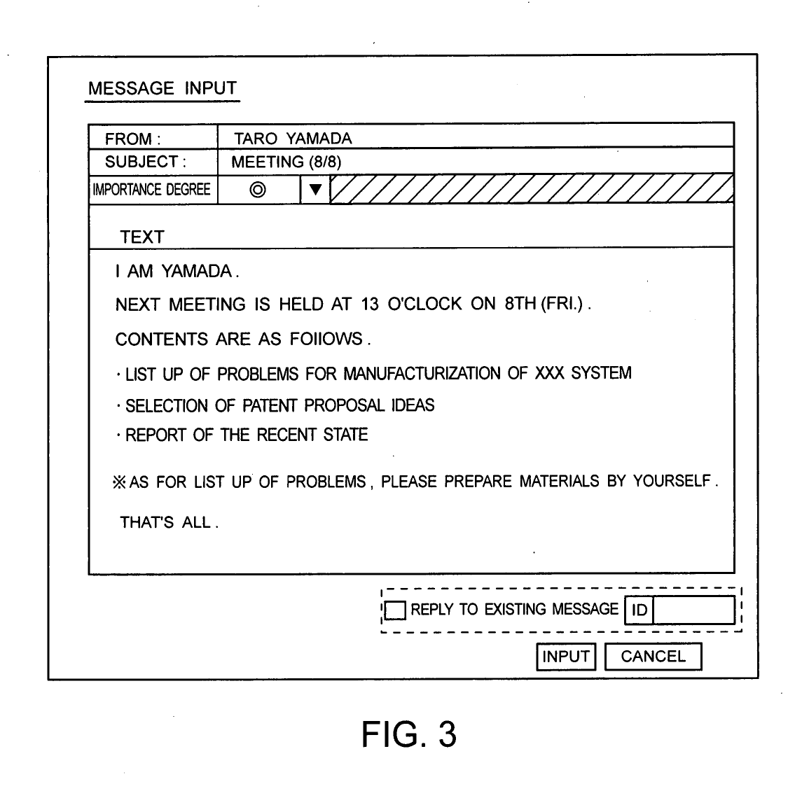

FIG. 3 is another example of the message input screen. This message input screen also corresponds to the message input unit 1, and a message of format such as E-mail can be input. This message with the ID, a name of input user, a title, an importance degree, an input time and the parent message ID, are stored in the message memory 2.

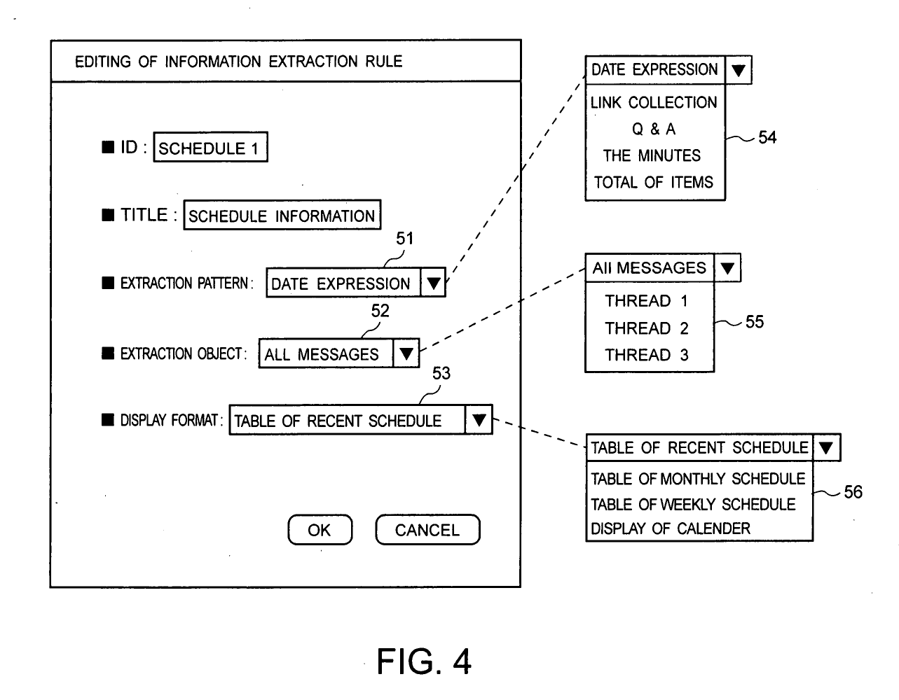

Next, editing of the information extraction rule, display of an information extraction result, and editing of the information extraction result are explained by referring to FIGS. 4, 5 and 6.

FIG. 4 is one example of an editing screen of the information extraction rule. The user can indicate an extraction rule ID (unique in the information extraction rule memory 5), a title to display the extraction result, an extraction pattern as a kind of information extraction, an extraction object, and a display format of the extraction result through the editing screen of information extraction rule. The indication is based on the user's operation such as (1) a direct input of characters and numerals into an input box and (2) a selection of at least one item from selectable items displayed in a pull-down menu.

For example, in the editing screen of information extraction rule of FIG. 4, an information extraction rule “date expression is extracted from all messages and displayed as a table of recent schedule.” is selected and displayed.

As shown in selection items 54 of extraction pattern of FIG. 4, as kinds of extractable information by the information extraction unit 4, for example, “date expression”, “link collection”, “Q and A”, “the minutes”, and “total of items” are presented.

In the case of “date expression”, actual date expression such as “Jul. 26, 2003” or “5/13 13:15-15:00” is extracted. Furthermore, information related to “a schedule name” and “a place” adjacent to the date expression can be extracted as schedule information.

In the case of “link collection”, a URL description such as “http://www.xxx.co.jp” and information related to “site explanation of URL” adjust to the URL description can be extracted.

In the case of “Q and A” and “the minutes”, as for a series of topics called a thread (comprises messages linked by reply), a description suitable to the extraction pattern is extracted based on a thread structure. For example, in the case of “Q and A”, a question sentence is extracted from a thread of messages including a keyword such as “question” as a subject. An answer part is extracted from a reply message for another message from which the question sentence is extracted or from the other message quoting the question sentence. By connecting the question sentence with the answer part, one question and one answer are extracted. Furthermore, in the case of “the minutes”, as for messages included in one thread, all descriptions are extracted except for unnecessary descriptions for the minutes such as a compliment (For example, “I am Haraguchi.”, “Thank you for your assistance.”) and a signature description. The all descriptions are arranged based on reply relationship or quotation relationship of a plurality of messages. As a result, the minutes are created. In this case, a technique for generating an abstract sentence as prior art can be utilized.

As shown in an item 52 of extraction object of FIG. 4, a message range of information extraction object can be edited. By using this item, information extraction can be repeatedly executed for a different message set as an object. As an example of information extraction, indication of all messages and indication of a different thread are given. Furthermore, in the case that the information extraction apparatus is used by a plurality of users through a network and the message range accessible by each user is different, an indication that all messages accessible by some user is possible.

By editing an item 53 of a display format, a display style of extraction result can be selected. Furthermore, by using a selection item 56 of a display format, in the case of extracting a date expression, for example, any can be selected from a plurality of candidates 6f display format such as “table of recent schedule”, “table of monthly schedule”, “table of weekly schedule” and “display of calendar”.

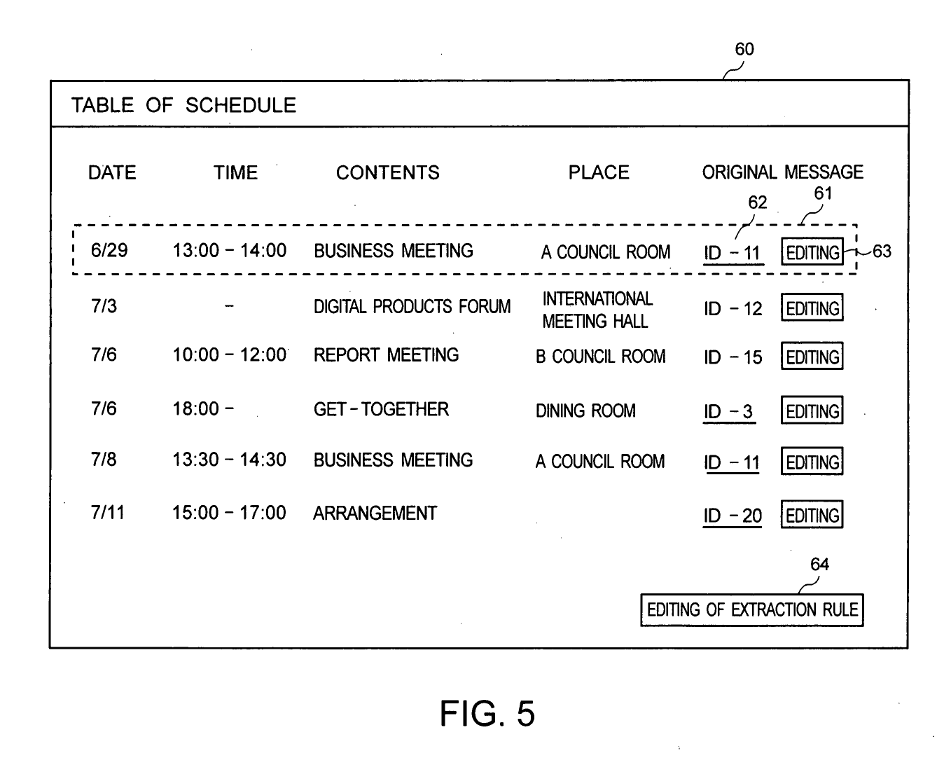

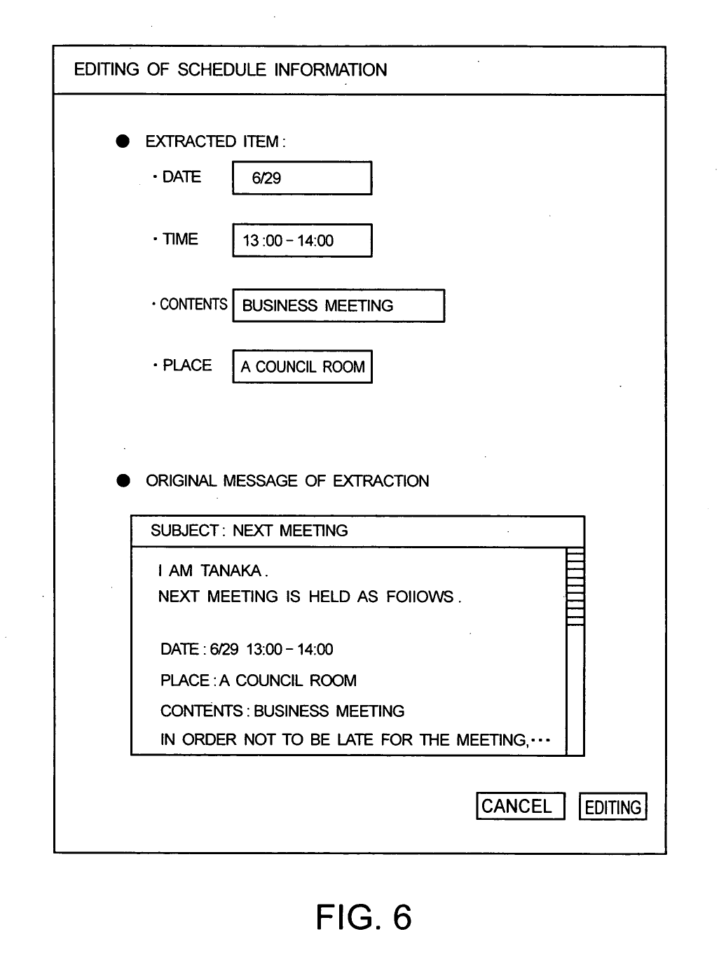

FIG. 5 is one example of a display screen of an extraction result in the case that information extraction is executed based on the information extraction rule set by editing screen of FIG. 4. By pushing an editing button 63 on this screen, an editing screen of schedule information shown in FIG. 6 is displayed. In the editing screen of schedule information, extracted items and a message identified by ID 62 (in FIG. 5) as an extraction source message are displayed. By referring to the extraction source message, the user can edit the extracted items by hand-operation.

Furthermore, in a screen of extraction result of FIG. 5, by pushing an editing button 64 of extraction rule, an editing screen of information extraction rule of FIG. 4 is displayed. Accordingly, the information extraction rule used for generation of this extraction result can be edited.

Next, automatic execution of information extraction is explained. In the automatic execution of information extraction, at the indicated timing, a decision whether an execution condition of information extraction is satisfied is executed. If the execution condition is satisfied, information extraction processing is automatically executed and the extraction result is presented to the user by a predetermined method. As for automatic execution of information extraction, the user can set the decision timing, the execution condition of information extraction, and a presentation method of extraction result through a set screen.

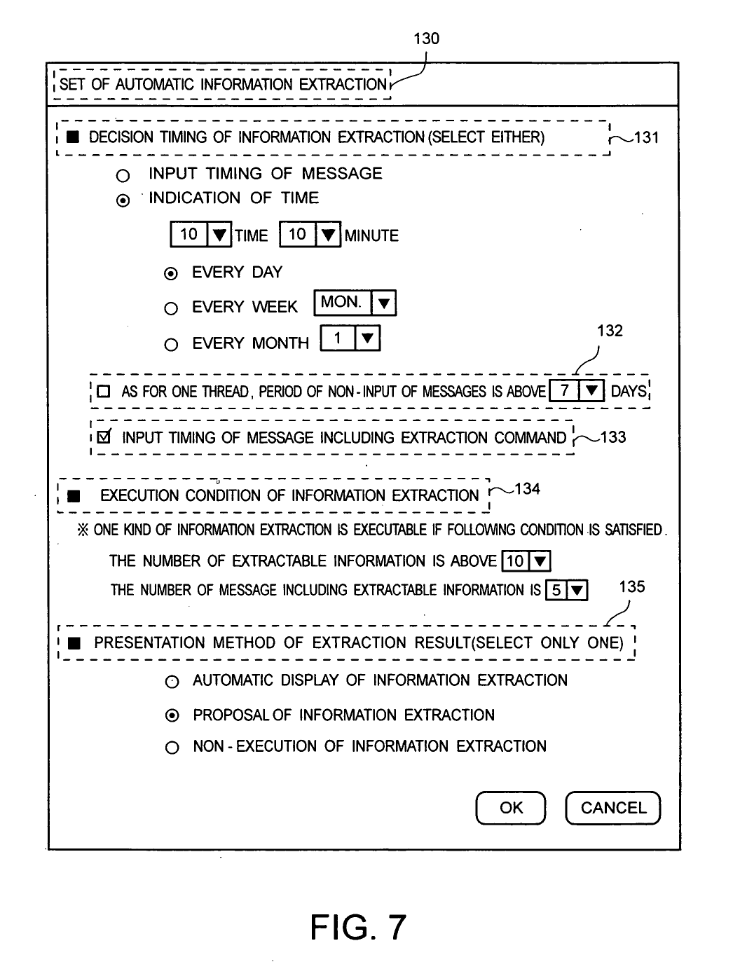

FIG. 7 is one example of the set screen of automatic information extraction. The set screen corresponds to the information extraction decision unit 3 in FIG. 1. As shown in FIG. 7, the user can indicate a decision timing 131 of information extraction, an execution condition 134 of information extraction, and a presentation method 135 of extraction result by a radio button, a check button, or a pull-down menu.

As for the decision timing 131 of information extraction, the user alternatively selects an input timing of a message or an indication of time. By selecting a check box 132, at a time when a period of non-input of messages for one thread is above indicated days, decision of information extraction is executed for messages included in the one thread. Furthermore, by selecting a check box 133, at a time when a message including an extraction command is input, it is decided whether information extraction represented by the command is executable. As an example of the extraction command, following description is shown.
(1) ##extract type:faq range:thread
(2) ##extract rule:faq_xyz_system
(3) ##extract type:summary range:thread mode:force

In the case of inputting a message including the extraction command (1), it is decided whether “Q and A” is extractable from a thread including the message. In the case of inputting a message including the extraction command (2), it is decided whether information extraction is executable based on extraction rule of ID “faq_xyz_system”. Furthermore, in the case of inputting a message including the extraction command (3), extraction of the minutes is compulsorily executed without decision of information extraction from a thread including the message.

As for the execution condition 134 of information extraction, a threshold is respectively set as the number or amount of extractable information and the number of messages each including extractable information for one kind (one rule) of information extraction. If the number or amount of actual extractable information or the number of actual extractable messages is above the threshold, information extraction is set to be automatically executed.

As for the presentation method 135 of extraction result, the user can set how to present the extraction result. In the case of selecting “automatic display of information extraction”, information extraction is automatically executed after the information extraction is decided to be extractable, and the extraction result is displayed through the extraction result display unit 6. In the case of selecting “proposal of information extraction”, information extraction is proposed to the user after the information extraction is decided to be extractable. In response to a confirmation of the proposal from the user, the information extraction is executed and the extraction result is displayed.

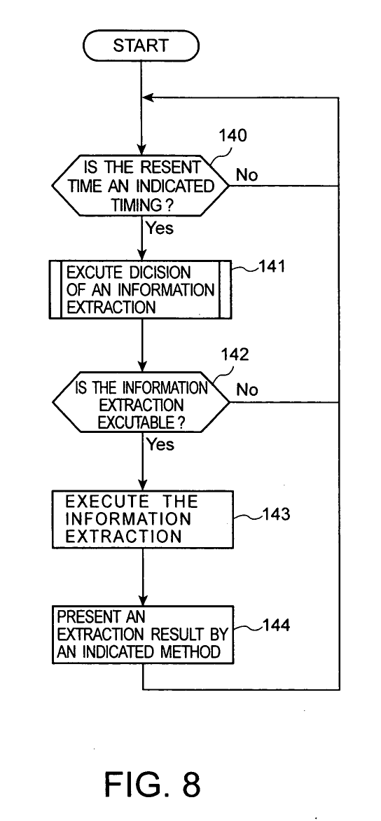

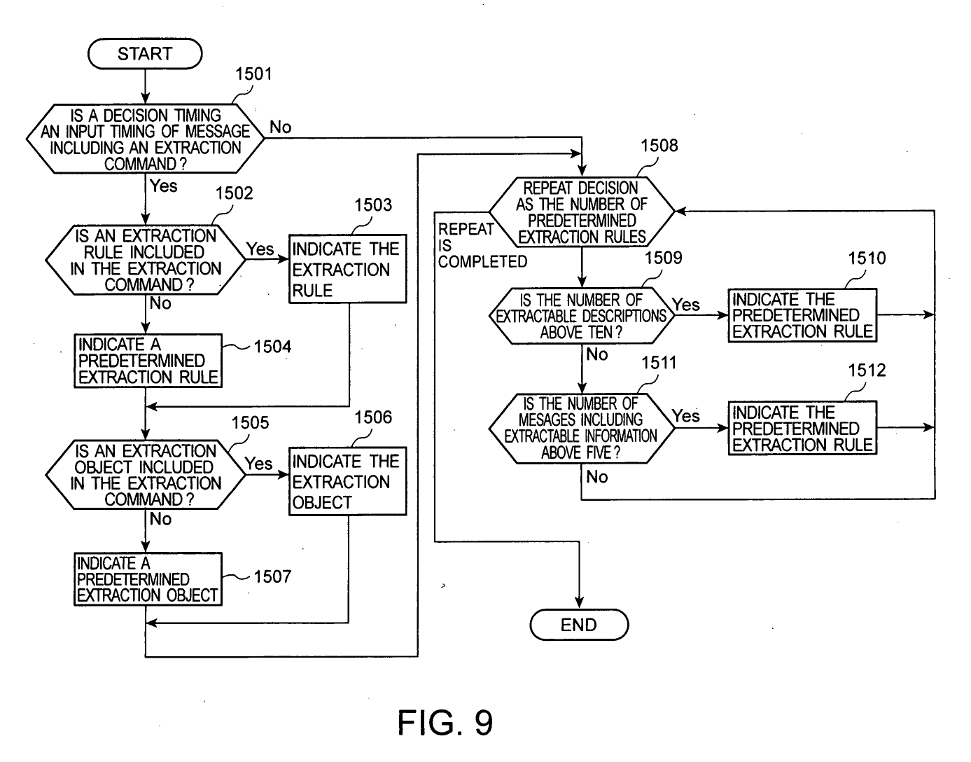

Next, execution processing of information extraction based on set of automatic information extraction on the screen of FIG. 7 is explained by referring to FIGS. 8 and 9.

FIG. 8 is a flow chart of general processing of execution control of information extraction. First, it is decided whether the present time is an indicated timing (step 140). In the case of YES at step 140, processing is forwarded to step 141. In the case of NO at step 140, processing is returned to the initial state. At step 141, it is decided whether the execution condition of information extraction is satisfied. If the execution condition of information extraction is satisfied, i.e., if an information extraction rule applicable to the messages exists, the information extraction decision unit 3 indicates the information extraction rule. If at least one information extraction rule is indicated, information extraction is decided to be executable. In this case, processing is YES at step 142; information extraction is executed at step 143; the extraction result is presented; and processing is returned to initial state (step 144). If information extraction is decided not to be executable at step 142, processing is returned to the initial state without information extraction.

FIG. 9 is a flow chart of detail processing of information extraction decision at step 141. First, as decision timing of information extraction, it is decided whether an input timing of a message including the extraction command is indicated. If the input timing of the message is indicated, information extraction is executed based on the extraction command (steps 1502˜1507). On the other hand, if the input timing of the message is not indicated, execution condition of information extraction is decided (steps 1508˜1512)/

In the latter case, each predetermined extraction rule is decided to be applicable to messages stored at the present time, and the amount of information as extractable description is totaled (step 1508). If the amount of information is above the indicated amount (For example, ten), the corresponding extraction rule is indicated (steps 1509˜1510). Furthermore, If the number of messages each including extractable description is above the indicated number (For example, five), the corresponding extraction rule is indicated (steps 1511˜1512). This processing is also executed after executing information extraction based on interpretation of the execution command (explained next).

On the other hand, in the case of indicating an input time of a message (including the extraction command) as the decision timing of information extraction (YES at step 1501), information extraction is executed by interpreting the extraction command.

As for interpretation of the extraction command, if an extraction rule is included in the command (YES at step 1502), the extraction rule is indicated (step 1503). If an extraction rule is not included in the command (NO at step 1502), a predetermined extraction rule is indicated (step 1504). In this case, a kind of information to be extracted is previously set. Accordingly, the predetermined rule matched with the kind of information is indicated. Next, if an extraction object is included in the command (YES at step 1505), the extraction object is indicated (step 1506). If an extraction object is not included in the command (NO at step 1505), a predetermined extraction object is indicated (step 1507).

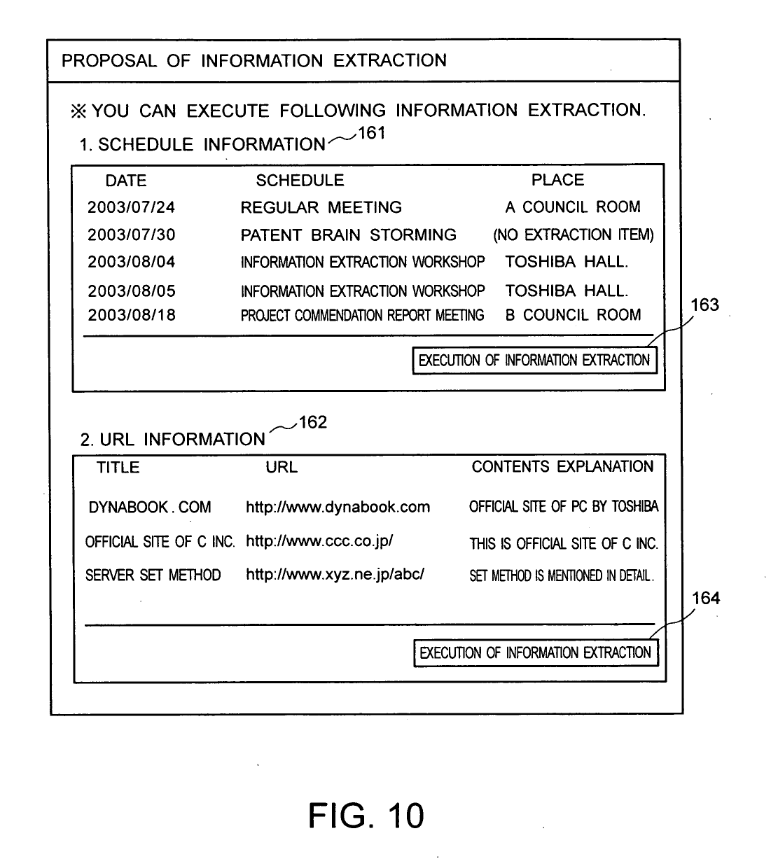

FIG. 10 is one example of a display screen of a proposed information extraction. Proposed information extraction is executed by indication of a presentation method 135 of extraction result on the set screen of automatic information extraction in FIG. 7. In the example of FIG. 10, two information extractions of schedule information 161 and URL information 162 are presented to the user as alternative proposals. By pushing an execution button 163 or 164 on this screen, the corresponding information extraction is actually executed, and the extraction result is displayed through the extraction result display unit 6.

The proposed information extraction may be executed by using not only a screen display but also a message notification. In the latter case, a message sending unit is added to the information extraction apparatus. When the information extraction decision unit 3 detects an applicable extraction rule, the message sending unit sends a message proposing an information extraction to the user. Alternatively, a decision result of information extraction may be displayed on a message input screen (For example, a message “URL information is extractable.” is displayed.).

As mentioned-above, in the first embodiment, at timing matched with the extraction decision condition, information extraction is automatically executed from stored messages by applying usable extraction rules. Alternatively, execution of information extraction can be proposed to the user. Accordingly, a user's operation burden for information extraction can be reduced. Furthermore, by proposing the user's unconscious information extraction to the user, a useful information extraction may be found for the user.

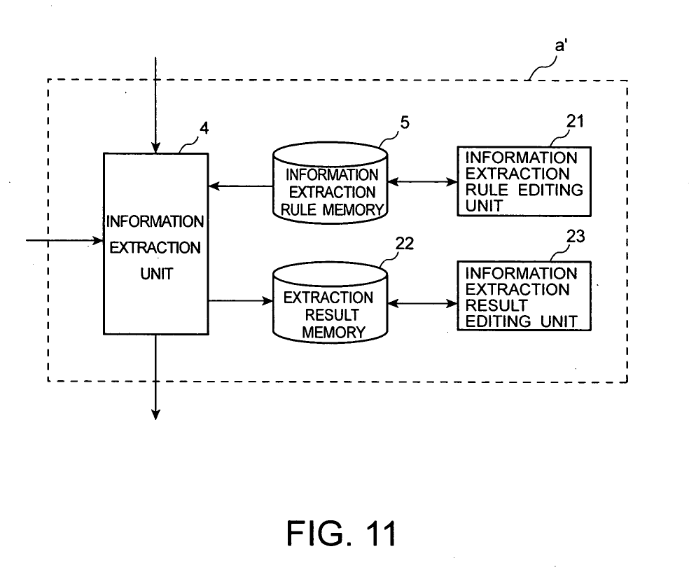

FIG. 11 is a block diagram of a specific part related to the editing of an information extraction rule according to the second embodiment of the present invention. As shown in FIG. 11, an information extraction rule editing unit 21, an extraction result memory 22, and an information extraction result editing unit 23 are added to components of FIG. 1 (the first embodiment).

In FIG. 11, a user can edit information extraction rules stored in the information extraction rule memory 5 using the information extraction rule editing unit 21. An editing object is predetermined information extraction rules previously stored in the information extraction rule memory 5. The user can also create new information extraction rules.

Information extracted by the information extraction unit 4 is stored in the extraction result memory 22. The extraction result can be edited using the information extraction result editing unit 23. Briefly, the extraction result based on some information extraction rule can be preserved and referred to as more refined data.

In order for the user to support automatic generation of an information extraction rule, the information extraction rule editing unit 21 recommends or supplements details of an information extraction rule based on rough information input by the user. This function is explained by using the information extraction rule “total of items” as an example.

As for “total of items”, for example, descriptions of format “A:B” such as “- - - product name: Notes PC SS 8; price: open price ; feature: lightweight - - - ” are collected from messages. Three items of “product name”, “price” and “feature” are counted and displayed as the extraction pattern.

In this case, if all extractable patterns “A:B” are extracted using this extraction rule, an item such as “date: July 27, 10˜12” different from the desired item is also extracted. Accordingly, keywords “product name”, “price” and “feature” should be indicated to the extraction rule. However, even if many users use the item “product name” in messages, some user may use another item such as “commodity name” having almost the same meaning as “product name”. It is difficult for the user to understand inconsistency of such descriptions and indicate a suitable keyword.

Accordingly, the information extraction rule editing unit 21 automatically presents another items similar to “A:B”. By the user's adding another item based on this presentation, accuracy of the extraction result rises.

Furthermore, in the case that some user newly prosecutes information extraction with intention “an instance applicable to total of items may exist”, it is difficult for the user to know keywords to be added to the rule or input all keywords. In this case, at a time when information extraction rules are newly created, all kinds of items to be extracted are presented. Furthermore, based on the user's selected item, information extraction rules are half or semi-automatically created. In this way, support of information extraction is possible.

Briefly, in editing support of information extraction rule, extractable information is always presented while editing the information extraction rule. When the information extraction rule is edited, extractable information is limited. When the user selects information to be extracted from the limited extractable information, the information extraction rule is set based on the selected information.

Next, a detailed editing support of an information extraction rule is explained by referring to screen examples of editing support and detail editing of the information extraction rule.

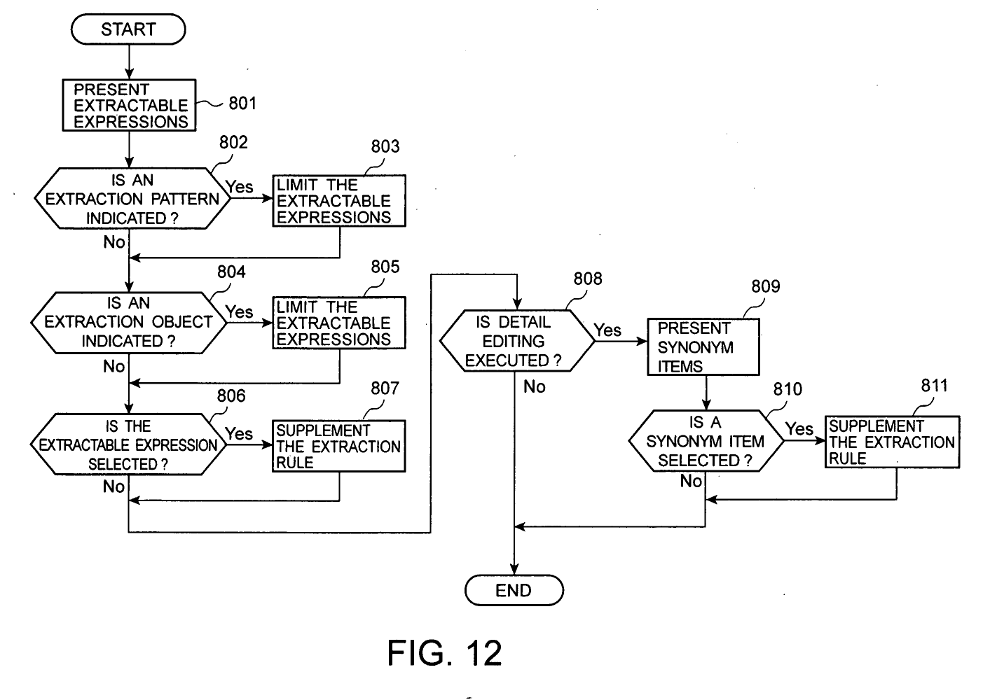

FIG. 12 is a flow chart of processing of editing support of information extraction rule. First, extractable expressions are presented (step 801). In the case of newly creating an information extraction rule, the extractable expressions correspond to all expressions extracted from all messages. In the case of editing, the extractable expressions correspond to limited information based on the rule.

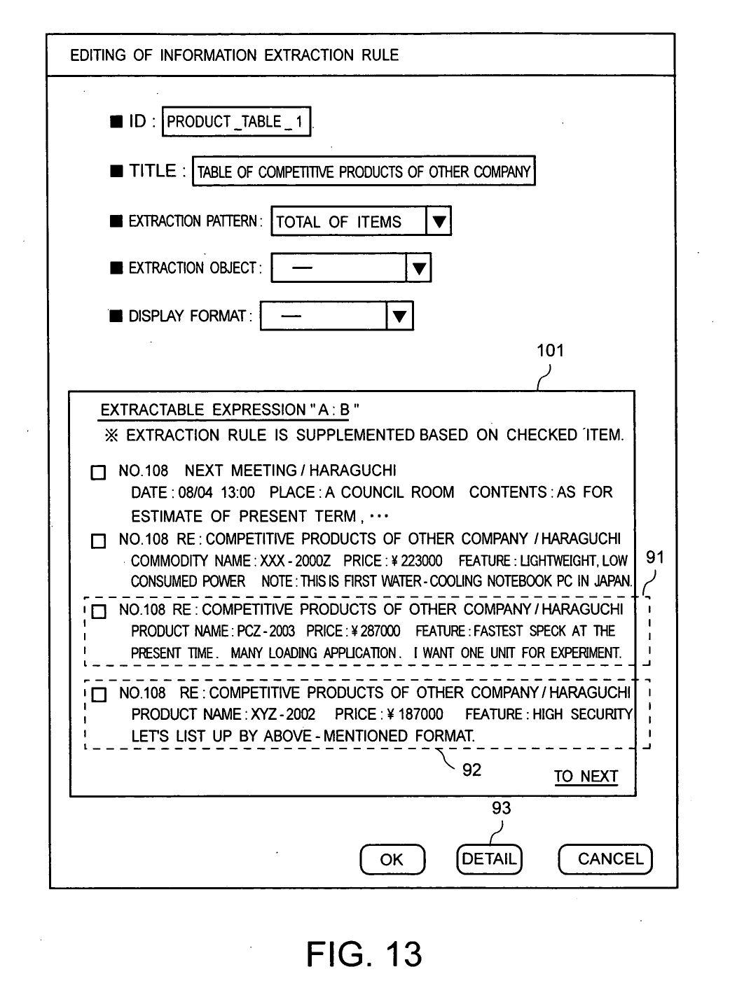

Next, if an extraction pattern is indicated (YES at step 802), extractable expressions are limited based on the extraction pattern (step 802). If an extraction pattern is not indicated (NO at step 802), processing is forwarded to step 804. FIG. 13 is one example of a support screen of information extraction editing. In FIG. 13, an ID, a title, and an extraction pattern of the information extraction rule are indicated. In the extraction pattern, “total of items” is indicated. Accordingly, information to be extracted by total of items is limited, and information of format “A:B” is presented as the extractable expression.

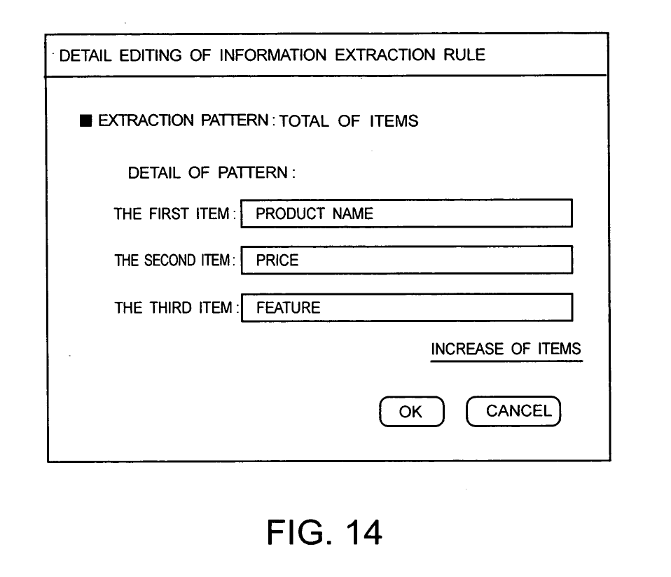

Next, if an extraction object is indicated (YES at step 804), extractable expressions are limited based on the extraction object (step 805). If the extraction object is not indicated (NO at step 804), processing is forwarded to step 806. At step 806, when at least one item is selected from presented extractable expressions, the information extraction rule is supplemented. For example, in FIG. 13, in the case of selecting extractable expressions 91 and 92, the information extraction rule is supplemented based on the expressions 91 and 92. By pushing a detail editing button 93, keywords to be automatically extracted are set as shown in a screen example of detail editing of information extraction rule of FIG. 14.

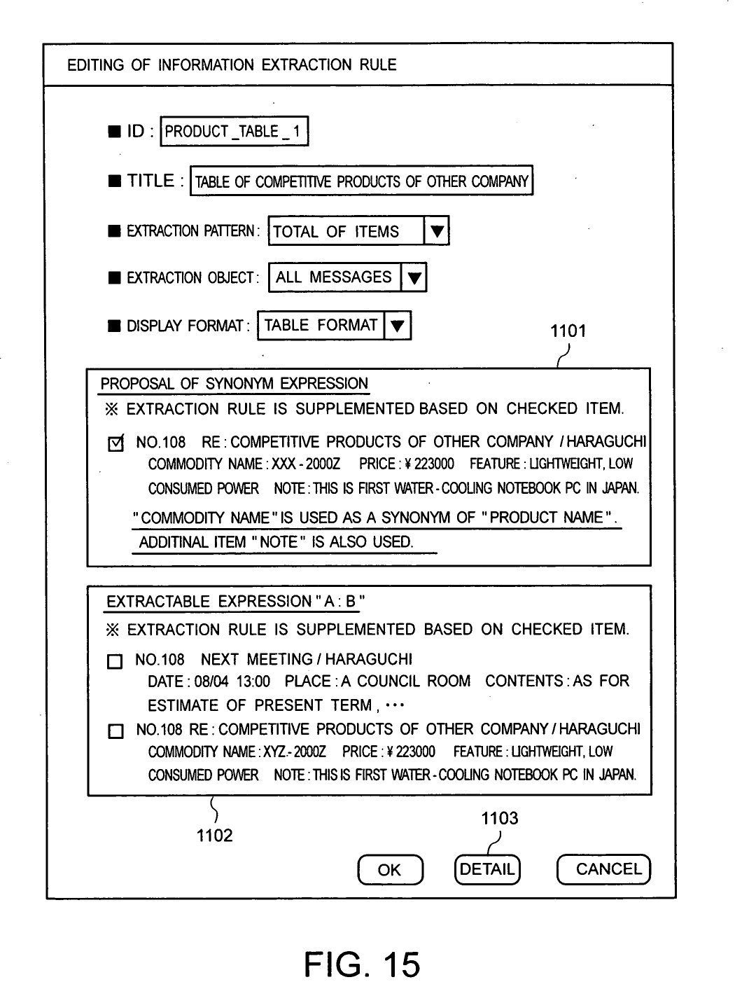

Next, if detail editing of information extraction rule is executed (YES at step 808), words as synonyms of the user's input patterns or keywords are presented as synonym items (step 809). For example, in the case of inputting each item shown in FIG. 14, a screen of editing support of information extraction rule is changed as shown in FIG. 15. In this case, items set on detail editing screen may be input by the user's hand operation or the items may be automatically supplemented. In FIG. 15, synonym items 1101 (“commodity name”, “price”, “feature” and “note”) are presented. In this example, a condition to present as synonym items represents that at least one item same as prescribed set items (“product name”, “price” and “feature” in FIG. 14) is included. Furthermore, contents “XXX-2000Z” of the item “commodity name” has similarity with contents “PCZ-2003” and “XYZ-2002” (FIG. 13) of prescribed item “product name”. Accordingly, “commodity name” is regarded as a substitute of “product name”. Another item “note” does not have similarity with contents of prescribed items. This item “note” is regarded as additional item because the number (four) of synonym items 1101 in FIG. 15 is larger than the number (three) of prescribed items 91 and 92 in FIG. 13.

In the case of measuring similarity between extracted items, a character type or a character sequence pattern is taken into consideration. As the character type, in addition to English letters, numerals, the square form of kana and hiragana, and distinction between a half size and a full size is given. As the character sequence pattern, a primitive pattern such as “English letters-English numerals” (used in this example), a date expression, and a pattern of fixed rule such as URL are given. Furthermore, in the case of using a dictionary of the name of a person or a company, similarity can be measured with high accuracy.

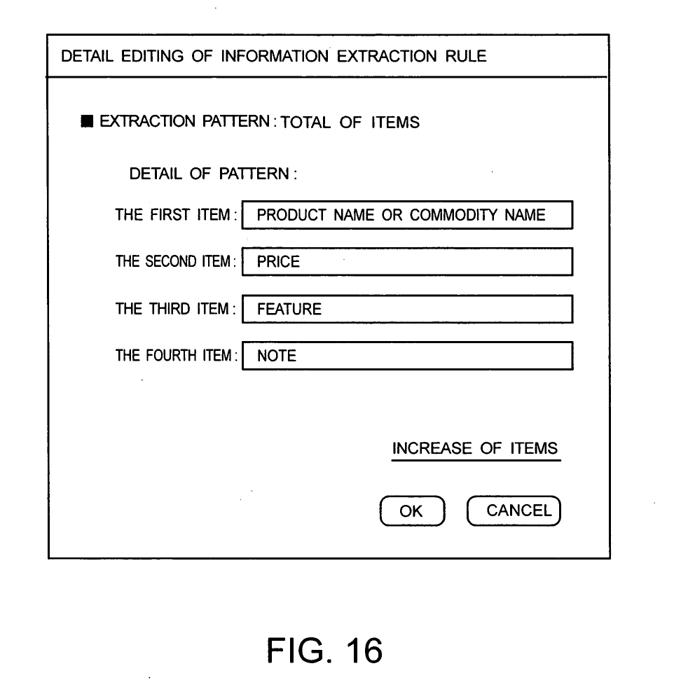

Next, if the presented synonym item is selected (YES at step 810), the information extraction rule is supplemented based on the synonym item (step 811). For example, as shown in FIG. 15, the presented synonym item 1101 is selected. In this case, by pushing a detail editing button 1103 to refer the detail editing screen, the information extraction rule is supplemented as shown in FIG. 16.

Furthermore, by displaying extraction result candidates during editing of information extraction rule and by selecting one from the extraction result candidates, the information extraction rule can be supplemented based on the one candidate. In this case, whenever the extraction rule is edited, information extraction is repeatedly executed based on the editing contents. Briefly, by selecting the displayed extraction result while updating, the extraction rule can be supplemented.

Next, a contents operation hysteresis memory added to a component of FIG. 11 is explained. The contents operation hysteresis memory stores a hysteresis of work as contents operation hysteresis during the information extraction rule editing or the information extraction result editing.

In a component including the contents operation hysteresis memory, information extraction decision can be executed using information of contents operation hysteresis. As data component of the contents operation hysteresis, an operation data, an operation user, an operation contents, and an operation object are included. As a kind of the contents operation, a creation, an inspection, an editing, and a deletion are included. For example, by a calculation equation “a×(the number of editing of extraction result)+b×(the number of inspection of extraction result) (a, b: constant)” for each extraction rule, an index representing how the information extraction rule was used can be measured. This index is called a recommendation degree of the information extraction rule.

As an example where the recommendation degree is applicable to information extraction decision, a system to exchange/commonly use messages by a plurality of users (such as a mailing list or BBS) is given. In this system, a structure to control access of each user is necessary for each message stored in the message memory. When the information extraction apparatus of the present invention is applied to this system, if a user A extracts information from messages not accessible by another user B, the information extraction result is not usually accessible by the user B.

However, if an information extraction rule created by the user A is a superior rule frequently used and applicable to messages accessible by the user B, by recommending use of this rule to the user B, effective information extraction is possible for the user B. For the purpose of reutilization of such information extraction rule, information extraction decision using the recommendation degree is possible. Furthermore, if the above-mentioned system includes an information extraction decision rule memory, an information extraction decision rule is stored in correspondence with each user or each topic. The information extraction decision rule represents set information (the decision timing, the execution condition, the presentation method) of automatic information extraction of FIG. 7 as a rule format. In this case, information extraction decision can be executed for each user or each topic.

As mentioned-above, in the present invention, by controlling execution of information extraction, the user's operability and convenience of the information extraction system improves. Especially, in the apparatus extracting information from stored messages, at timing matched with the extraction decision condition, information is automatically extracted from the stored messages by applying usable extraction rules. Alternatively, execution of information extraction is proposed to the user. Accordingly, burden of the user's operation of information extraction can be reduced. Furthermore, by proposing the user's unconscious information extraction, useful information extraction can be found out for the user.

In embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through a network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. An information extraction apparatus, comprising:
a message input unit configured to input a message;
a message memory configured to store the message;
an information extraction rule memory configured to store a plurality of information extraction rules;
an information extraction decision unit configured to decide whether at least one of the plurality of information extraction rules is applicable to the message; and
an information extraction unit configured to extract information from the message using at least one information extraction rule when the at least one information extraction rule is applicable to the message.

2. The information extraction apparatus according to claim 1,
wherein said information extraction decision unit decides whether at least one of the plurality of information extraction rules is applicable at a decision timing, and
wherein the decision timing is a periodical time or an input time of the message.

3. The information extraction apparatus according to claim 2,
wherein said message input unit inputs a plurality of messages in time series, and
wherein said message memory stores the plurality of messages in order.

4. The information extraction apparatus according to claim 3, further comprising:
an extraction result display unit configured to display the extracted information.

5. The information extraction apparatus according to claim 4,
wherein the information extraction rule includes an extraction pattern, an extraction object and a display format, and
wherein the extraction pattern, the extraction object and the display format respectively include a plurality of predetermined items to be selected by a user through said extraction result display unit.

6. The information extraction apparatus according to claim 4,
wherein said extraction result display unit displays the extracted information with the message, and
wherein the information displayed with the message is edited by the user through said message input unit.

7. The information extraction apparatus according to claim 4,
wherein said information extraction decision unit presents a set of automatic information extraction including the decision timing, an execution condition of information extraction, and a presentation method of extraction result through said extraction result display unit.

8. The information extraction apparatus according to claim 7,
wherein selection items of the decision timing include the input time of the message, an indication of time, a period of non-input of message for one thread, and an input time of a message including an extraction command.

9. The information extraction apparatus according to claim 8,
wherein selection items of the execution condition of information extraction include an amount of information to be extracted by the same information extraction rule, and a number of messages including information to be extracted by the same information extraction rule.

10. The information extraction apparatus according to claim 9,
wherein selection items of the presentation method of extraction result include a display of extraction result by automatic extraction, a proposal of information extraction, and non-execution of information extraction.

11. The information extraction apparatus according to claim 8,
wherein, if the decision timing is the input time of the message including the extraction command, said information extraction decision unit interprets the extraction command, and decides whether information extraction is possible based on an interpretation result.

12. The information extraction apparatus according to claim 11,
wherein, if the extraction command includes an information extraction rule, said information extraction decision unit decides that the information extraction rule is applicable to the message.

13. The information extraction apparatus according to claim 9,
wherein said information extraction decision unit decides whether an amount of information extracted from the plurality of messages by the same information extraction rule is above the amount of information as the execution condition of information extraction, and decides that the same information extraction rule is applicable if the execution condition is satisfied.

14. The information extraction apparatus according to claim 13,
wherein said information extraction decision unit decides whether a number of messages extracted from the plurality of messages by the same information extraction rule is above the number of messages as the execution condition of information extraction, and decides that the same information extraction rule is applicable if the execution condition is satisfied.

15. The information extraction apparatus according to claim 5, further comprising:
an information extraction rule editing unit configured to extract all expressions from the plurality of messages, and present the all expressions as all extractable expressions through said extraction result display unit.

16. The information extraction apparatus according to claim 15,
wherein, if at least one of the extraction pattern and the extraction object is indicated by the user through said message input unit, said information extraction rule editing unit selects at least one extractable expression from the all extractable expressions based on the indication result.

17. The information extraction apparatus according to claim 16,
wherein said information extraction rule editing unit extracts synonym items similar to the at least one extractable expression from the plurality of messages, and presents the synonym items for editing the information extraction rule through said extraction result display unit.

18. The information extraction apparatus according to claim 17,
wherein, if at least one synonym item is selected from the synonym items by the user through said message input unit, said information extraction rule editing unit supplements the information extraction rule by adding the at least one synonym item to the at least one extractable expression.

19. An information extraction method, comprising:
inputting a message;
storing the message;
storing a plurality of information extraction rules;
deciding whether at least one of the plurality of information extraction rules is applicable to the message; and
extracting information from the message using at least one information extraction rule when the at least one information extraction rule is applicable to the message.

20. A computer program product, comprising:
a computer readable program code embodied in said product for causing a computer to extract information, said computer readable program code comprising:
a first program code to input a message;
a second program code to store the message;
a third program code to store a plurality of information extraction rules;
a fourth program code to decide whether at least one of the plurality of information extraction rules is applicable to the message; and
a fifth program code to extract information from the message using at least one information extraction rule when the at least one information extraction rule is applicable to the message.
